(19) United States
(12) Patent Application Publication
(10) Pub. No.: US 2003/0207212 A1
(43) Pub. Date: Nov. 6, 2003

(54) Micro-optics device and method for fabricating

(76) Inventors: Benjamin Pain-Fong Law, Fremont, CA (US); Jonathan N. Simon, Castrovalley, CA (US); Kirk S. Giboney, Santa Rosa, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/137,630

(22) Filed: May 2, 2002

(51) Int. Cl. G03C 5/00

(52) U.S. Cl. 430/311; 430/321

(57) ABSTRACT

A micro-optics device and a method for fabricating the micro-optics device is provided using one or more layers of an optically-transparent polymer resist having a viscosity between 2,000 and 100,000 centipoise or that is otherwise sufficient to allow stacking of one or more layers of the resist at a thickness of at least 10 microns per layer of resist. Each layer of the polymer resist is deposited onto a substrate and defined photolithographically to build a discrete relief structure upon which a final smoothing layer of polymer resist can be applied.

### BACKGROUND OF THE INVENTION

1. Technical Field of the Invention

The invention relates generally to fabrication of micro-optics devices, and specifically to fabrication of micro-optics devices using a polymer process.

2. Description of Related Art

Microlens fabrication is an important technique in the quest to build compact fiber optical telecommunications devices capable of operating at terabit speeds. In these compact devices, the lenses that are used to align and focus incoming and outgoing light signals are becoming smaller and are being placed closer to miniature detectors or light sources, such as Vertical Cavity Surface Emitting Lasers (VCSELs).

Various types of microlens fabrication techniques have been used in the optical telecommunications industry, such as polymer stamping or molding processes and polymer reflow processes. However, the typical polymers used in the polymer stamping or molding processes and polymer reflow processes are low viscosity polymers that do not perform well at temperatures above 250° C. In applications where the assembly fabrication temperature may be in excess of 300° C., the optical properties of the microlens array may deteriorate due to shape deformation and material discoloration caused by the high fabrication temperatures. In addition, low viscosity polymers are typically not capable of producing thick lenses, which may be required depending upon the application. Furthermore, the lens shapes attainable by typical photoresist materials are limited by the surface tension of the photoresist in liquid form.

Therefore, what is needed is an economical microlens fabrication technique that produces microlenses capable of withstanding subsequent high processing temperatures and allows the lens shape and height to be controlled.

### SUMMARY OF THE INVENTION

Embodiments in accordance with the invention provide a micro-optics device and a method for fabricating the micro-optics device using one or more layers of an optically-transparent polymer resist material having a viscosity sufficient to allow stacking of the layers of resist at a thickness of at least ten microns per resist layer. For example, the viscosity of the polymer resist material can be between 2,000 and 100,000 centipoise. Each layer of the polymer resist is deposited onto a substrate and defined photolithographically to build a discrete relief structure upon which a final smoothing layer of polymer resist having a variable viscosity can be applied. Polymer resists having viscosities at or above 2,000 centipoise enable thick lenses to be produced. In addition, the higher viscosity of the polymer resist allows precise control of the lithography process to form a smooth curvature and shape of the lens.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a flowchart illustrating exemplary steps for fabricating a micro-optics device in accordance with embodiments of the invention;

FIGS. 2A-2G are cross-sectional views illustrating the fabrication of a micro-optics device in accordance with one embodiment of the invention;

FIG. 3 is a flowchart illustrating exemplary steps for fabricating a micro-optics device in accordance with the embodiment shown in FIGS. 2A-2G;

FIGS. 4A-4F are cross-sectional views illustrating the fabrication of a micro-optics device in accordance with another embodiment of the invention;

FIG. 5 is a flowchart illustrating exemplary steps for fabricating a micro-optics device in accordance with the embodiment shown in FIGS. 4A-4F;

FIGS. 6A-6I are cross-sectional views illustrating the fabrication of a micro-optics device in accordance with another embodiment of the invention; and

FIG. 7 is a flowchart illustrating exemplary steps for fabricating a micro-optics device in accordance with the embodiment shown in FIGS. 6A-6I.

### DETAILED DESCRIPTION OF THE EXEMPLARY EMBODIMENTS

As used herein, the term “resist” is defined as a polymer resist material that is transparent to optical wavelengths equal to or greater than 350 nm and that has a viscosity sufficient to allow stacking of layers of the resist at a thickness of at least 10 microns (e.g., between 10 and 300 microns) per resist layer. For example, the viscosity of the polymer resist material can be between 2,000 and 100,000 centipoise, 2,500 and 100,000 centipoise, 3,000 and 100,000 centipoise, 3,500 and 100,000 centipoise, 4,000 and 100,000 centipoise, 4,500 and 100,000 centipoise or 5,000 and 100,000 centipoise. The high viscosity (e.g., at or above 2,000 centipoise) of the resist material allows for thick films (up to mm range) to be produced, and therefore, thick lenses to be produced. Furthermore, the optical transparency of the resist material enables the resist to be used as a lens material and allows the thick films produced by the resist to be thermally cured down to the substrate.

In one embodiment, the resist is an epoxy-based polymer resist. Epoxy-based polymer resist materials are able to be flowed at low temperatures before the polymer becomes crosslinked and, after subsequent processing, the materials are stable at temperatures above 250° C. (i.e., the resist will not reflow during subsequent processing as many other polymers do). An example of an epoxy-based polymer resist is SU-8, which is a commercially available resist developed by IBM and sold by MicroChem Corporation. SU-8 becomes chemically inert and immovable once exposed to ultraviolet (UV) light and thermally cured.

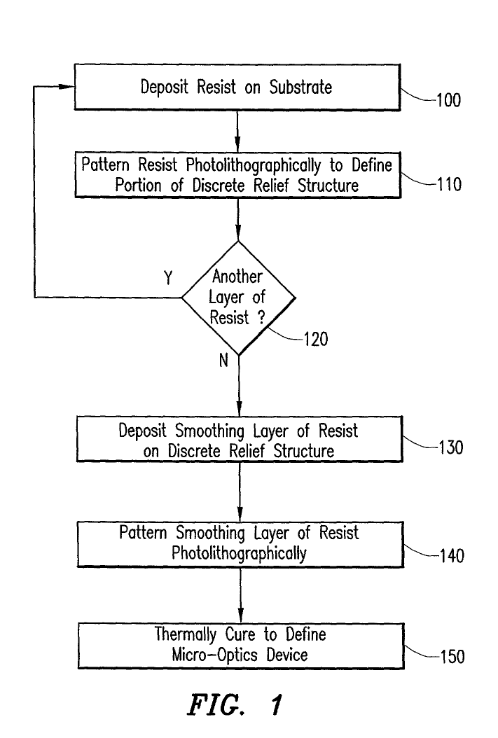

FIG. 1 illustrates exemplary steps for fabricating a micro-optics device in accordance with embodiments of the invention. A layer of the resist is deposited onto a substrate (step 100) and patterned photolithographically to define a first lens layer (step 110). The substrate can be a substrate transparent to light within a particular range of wavelengths (e.g., visible, x-ray, infrared) and include one or more layers of an anti-reflection material, such as dielectric materials of appropriate optical indices and thicknesses. In other embodiments, for reflection optics applications, the substrate need not be transparent, and can include one or more layers of a reflection material, such as metallic materials and/or dielectric materials of appropriate optical indices and thicknesses.

To obtain the desired geometry of the micro-optics device, additional layers of the resist (step 120) can be deposited (step 100) and patterned photolithographically (step 110) to build a complete lens structure. A final smoothing layer of the resist can be deposited over the lens structure (step 130), patterned (step 140) and thermally cured (step 150) to provide a smooth surface for the micro-optic device. For example, the substrate can be placed either on a hot plate or in an oven at a temperature between 90° C. and 120° C. However, it should be understood that other temperatures may be used, depending upon the materials involved. The resulting micro-optics device can contain, for example, one or more of each of the following types of microlenses: concave lenses, convex lenses, circular lenses, elliptical shape lenses, prisms, Fresnel lenses, gratings and diffractive optics. Moreover, the micro-optics device fabrication technique enables easy integration of the micro-optics device into an assembly and allows the micro-optics device to be packaged together with other IC components economically.

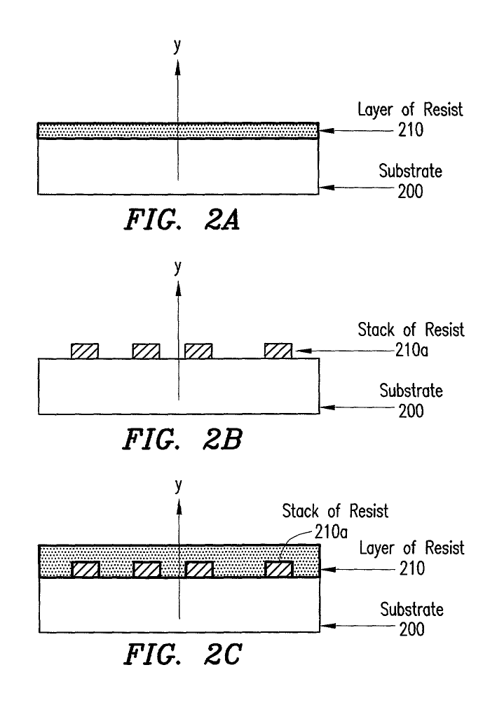

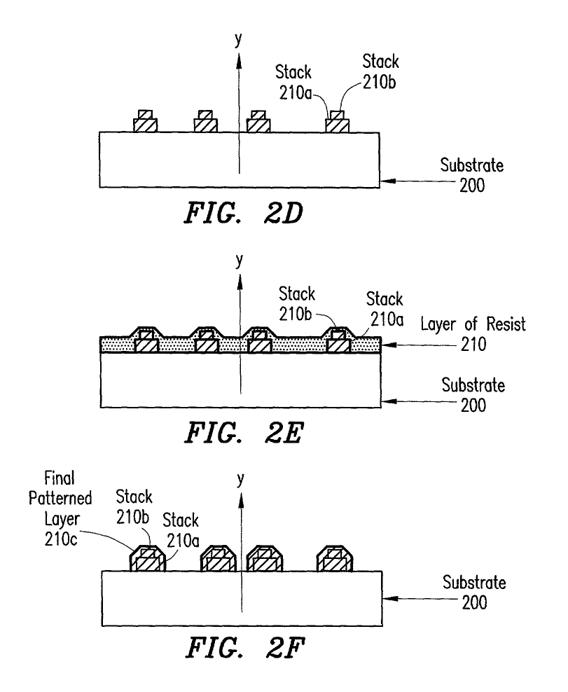

In one embodiment, as shown in FIGS. 2A-2G, a micro-optics device, such as an array of microlenses, is fabricated in a series of pattern steps. In each step, layer of an epoxy-based, negative-working, photo-definable polymer resist 210 is deposited on substrate 200, such as quartz or glass. Resist 210 can be deposited using any known deposition process, such as, for example, spin-coating. An example of a spin-coating process is as follows: (1) place the substrate on a vacuum chuck; (2) dispense the resist over the substrate in a static mode; (3) spin the substrate up to a set speed (e.g., 500-5000 rpm); (4) maintain the set speed for certain period of time; and (5) ramp down the speed until the substrate stops spinning. During the spin cycle, the resist spreads and coats the surface of the substrate. Excess resist is spun off in order to produce the desired resist film thickness. The result of the deposition process is layer of resist 210 overlying substrate 200, as shown in FIG. 2A.

After deposition of layer of resist 210 onto substrate 200, the edges of the lenses are defined photolithographically, as shown in FIG. 2B. For example, in a standard photolithography process, resist 210 is exposed to ultraviolet (UV) light (e.g., 350 nm-400 nm) with a photo-mask at room temperature, and then baked at a typical temperature of between 95° C. and 120° C. (although other temperatures may be used, depending upon the materials involved). The UV light changes the property of exposed resist 210 to be easy or difficult to dissolve in a developer solution based on the tone of resist 210 (negative or positive tone). Negative-working polymer resist 210 shown in FIG. 2B becomes cross-linked (i.e., hard) in the exposed regions, and therefore, resistant to developer solution. The unexposed regions of resist 210 dissolve in the developer solution, leaving the desired pattern of one or more stacks 210a of the first layer of resist, as shown in FIG. 2B. For example, in some embodiments, the developer solution can be propylene glycol monomethyl ether acetate (PGMEA). However, it should be understood that other developer solutions may be used, depending upon the materials involved.

In FIG. 2C, second layer of resist 210 is shown deposited (e.g., spin-coated) over patterned stacks 210a in the first layer of resist. Second layer of resist 210 is also patterned photolithographically to define one or more stacks 210b of the second layer of resist overlying one or more of the stacks 210a of the first layer of resist. As shown in FIG. 2D, second layer stacks 210b are smaller in area than first layer stacks 210a to create “pedestal” stacks of resist material. Subsequent layers of resist, not shown, can be deposited and defined in a stair case elevation pattern, where bottom pedestal 210a has the largest area and top pedestal 210b has the smallest area. The height and curvature of the lens is determined by the number of resist layers and the outer edge diameters of each resist layer.

As shown in FIG. 2E, final smoothing layer of resist 210 is spin-coated over previous patterned stacks 210a and 210b of resist. It should be noted that final layer of resist 210 can have a variable viscosity that is less than the viscosity of other resist layers (e.g., less than 2,000 centipoise). Final layer of resist 210 is also exposed to UV light with the photo-mask used in defining the edges of the lenses for the first layer of resist and developed, such that final patterned layer of resist 210c covers all other stacks 210a and 210b of resist, as shown in FIG. 2F. Resulting stack of resist layers 210a, 210b and 210c is thermally cured (i.e., soft baked) to allow final patterned layer 210c to flow smoothly over other resist stacks 210a and 210b to cover stacks 210a and 210b and fill in between stacks 210a and 210b. Surface tension resulting from the thermal cure process pulls the shape of final patterned layer 210c of resist into lens 220 having a curved surface, as shown in FIG. 2G. To finalize the shape and size of lens 220, lens 220 is blanket exposed (i.e., no mask is used) with UV to cross-link the polymer material in order to harden lens 220.

The fabrication process produces lithographically defined geometries in a polymer. For example, the fabrication process enables control of various lens parameters, such as the height, diameter and figure of the lens. FIG. 2G further illustrates several examples of lens parameters that are variable using the fabrication process described above. The parameters are as follows: curvature of a concave lens 220a; diameter of a concave lens 220b; curvature of a convex lens 220c; diameter of a convex lens 220d; and height of the lenses 220e. However, it should be understood that the lens parameters capable of being controlled by the fabrication process of the invention are not limited to those shown in FIG. 2G, but rather can be extended to any lens geometry.

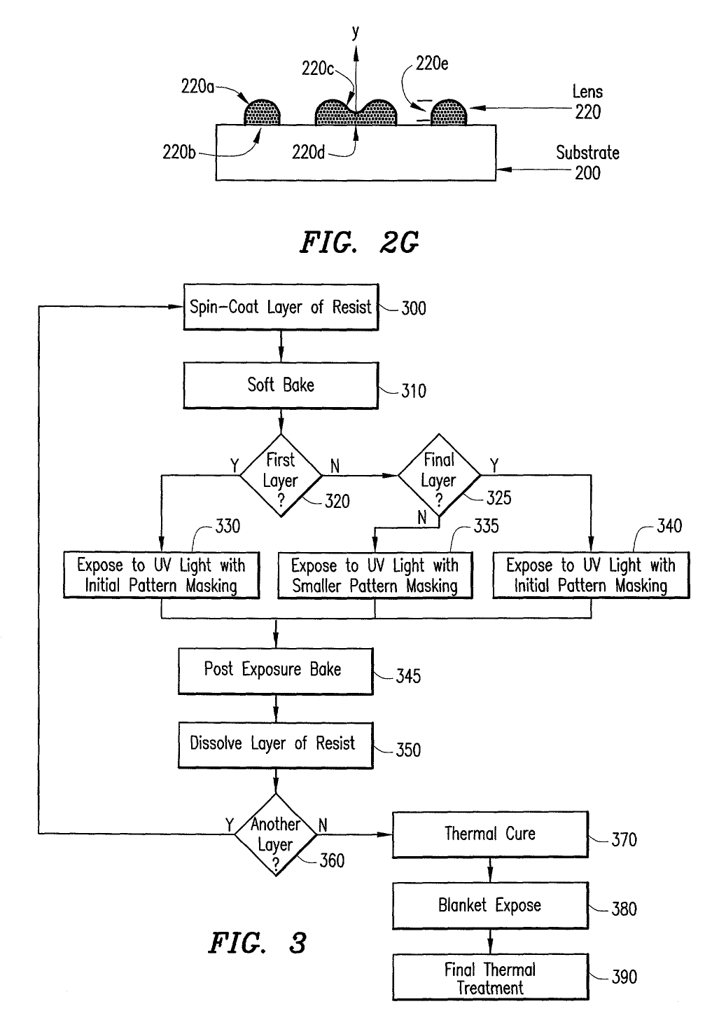

FIG. 3 is a flowchart illustrating exemplary steps for fabricating a micro-optics device in accordance with the embodiment shown in FIGS. 2A-2G. An initial layer of an epoxy-based negative-working photo-definable polymer resist is spin-coated onto a substrate (step 300). If desired, the substrate with the layer of resist thereon can be thermally cured (step 310) (i.e., soft baked) as a precursor to photolithography. In the initial photolithography step (step 320), the edges of the lenses are defined by exposing the resist to ultraviolet (UV) light (e.g., 350 nm-400 nm) with a photo-mask having an initial pattern masking (step 330), subjecting the resist to a post exposure bake (step 345) and dissolving away unexposed regions of the resist in a developer solution (step 350), leaving one or more stacks of resist material.

If additional layers of resist are to be applied (depending upon the desired height and curvature of the lens) (step 360), each additional layer of resist is spin-coated (step 300) over the previously defined stack(s) of resist, soft-baked (step 310) and photolithographically patterned using a photo-mask having a smaller pattern masking that is capable of defining one or more stacks of resist that are smaller in area than the immediately preceding stacks of resist and that overly one or more of the immediately preceding stacks of resist (step 335). The resist is then baked (step 345), and unexposed areas of resist are dissolved away in developer solution (step 350), leaving a stair case elevation pattern of “pedestals” of resist, where the bottom pedestal of resist has the largest area and the top pedestal of resist has the smallest area.

A final smoothing layer of resist (step 360) is spin-coated over the previous patterned stacks of resist (step 300) and soft-baked (step 310). The final layer (step 325) is also exposed to UV light with the initial photo-mask used in defining the edges of the lenses for the first layer of resist (step 340), subjected to a post exposure bake (step 345) and developed (step 350), such that the final patterned layer of resist covers all other layers of resist. The resulting stack of resist layers (step 360) is thermally cured (step 370) to allow the final layer to flow smoothly over the other resist layers to cover the layers and fill in between the layers. The surface tension of the melted final layer of resist pulls the final resist layer into a lens shape having a curved surface. To finalize the lens shape and size, the lens is blanket exposed (i.e., no mask is used) with UV to cross-link the polymer material in order to harden the lens (step 380). A final thermal treatment can be applied, if necessary, to cure the lenses further to improve performance in subsequent processing (step 390).

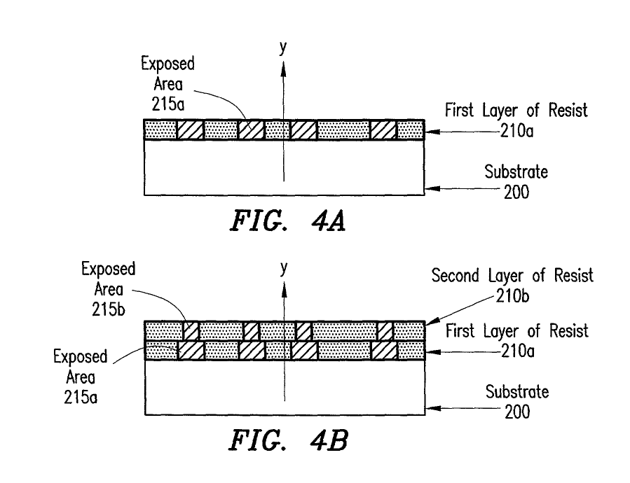

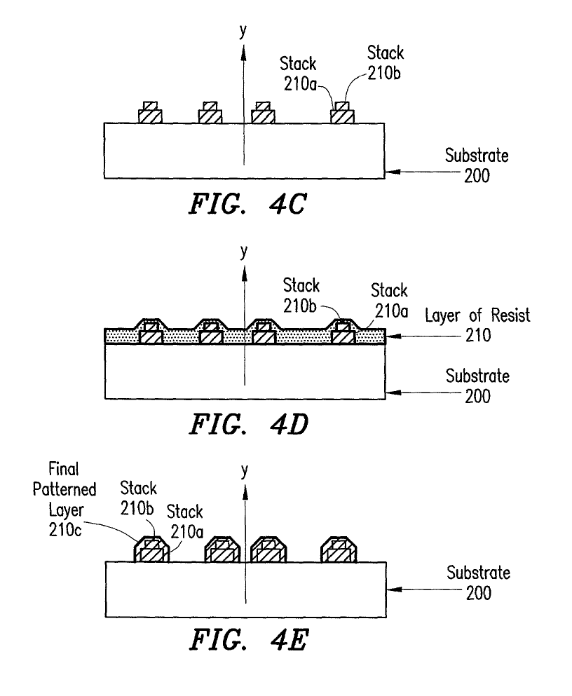

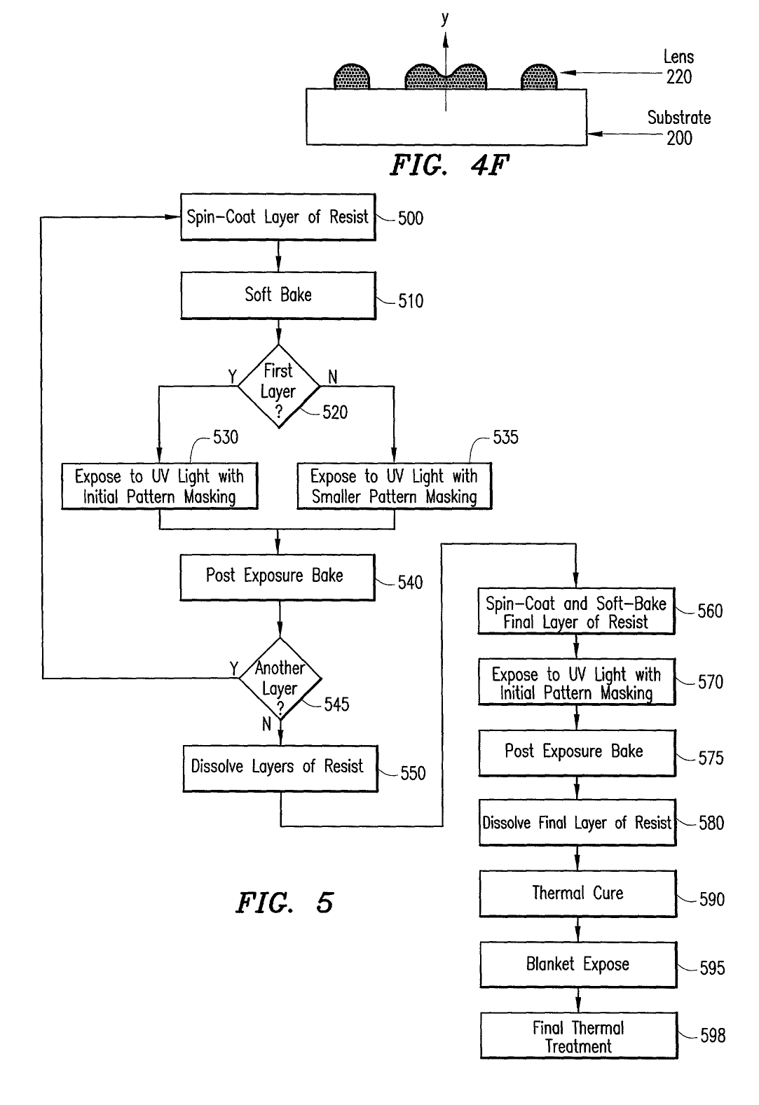

In another embodiment, as shown in FIGS. 4A-4I, an alternate series of pattern steps can be used to fabricate a micro-optics device. First layer of an epoxy-based negative-working photo-definable polymer resist 210a is deposited on substrate 200. First layer of resist 210a is exposed to ultraviolet (UV) light (e.g., 350 nm-400 nm) with a photo-mask to become cross-linked (i.e., hard) in exposed regions 215a, and therefore, resistant to developer solution. In FIG. 4B, second layer of resist 210b is shown deposited (e.g., spin-coated) over the first layer of resist. Second layer of resist 210b is also exposed to UV light using a photo-mask that allows smaller areas 215b of the second layer of resist to be exposed, as compared to first layer of resist 210a. Subsequent layers of resist, not shown, can be deposited and exposed in a stair case elevation pattern, where exposed area 215a of bottom layer 210a has the largest area and exposed area 215b of top layer 210b has the smallest area. The unexposed regions of layers of resist 210a and 210b are dissolved together in the developer solution, leaving the desired pattern of one or more stacks 210a and 210b of resist, as shown in FIG. 4C.

As shown in FIG. 4D, final smoothing layer of resist 210 is spin-coated over previous patterned stacks 210a and 210b of resist. Final layer of resist 210 is also exposed to UV light with the photo-mask used in defining the edges of the lenses for the first layer of resist and developed, such that final patterned layer of resist 210c covers all other stacks 210a and 210b of resist, as shown in FIG. 4E. Resulting stack of resist layers 210a, 210b and 210c is thermally cured (i.e., soft baked) to allow final patterned layer 210c to flow smoothly over other resist stacks 210a and 210b to cover stacks 210a and 210b and fill in between stacks 210a and 210b. Surface tension resulting from the thermal cure process pulls the shape of final patterned layer 210c of resist into lens 220 having a curved surface, as shown in FIG. 4F. To finalize the shape and size of lens 220, lens 220 is blanket exposed (i.e., no mask is used) with UV to cross-link the polymer material in order to harden lens 220.

FIG. 5 is a flowchart illustrating exemplary steps for fabricating a micro-optics device in accordance with the embodiment shown in FIGS. 4A-4F. An initial layer of an epoxy-based negative-working photo-definable polymer resist is spin-coated onto a substrate (step 500). If desired, the substrate with the layer of resist thereon can be thermally cured (step 510) (i.e., soft baked) as a precursor to photolithography. In the initial photolithography step (step 520), the edges of the lenses are defined by exposing the resist to ultraviolet (UV) light (e.g., 350 nm-400 nm) with a photo-mask with an initial pattern masking (step 530) and baking the resist (step 540) to cross-link (i.e., harden) the resist in the exposed regions. If additional layers of resist are to be applied (depending upon the desired height and curvature of the lens) (step 545), each additional layer of resist is spin-coated (step 500) over the previously defined stack(s) of resist, soft-baked (step 510) and exposed to UV light using a photo-mask having a smaller pattern masking that is capable of defining one or more stacks of resist that are smaller in area than the immediately preceding stacks of resist and that overly one or more of the immediately preceding stacks of resist (step 535). The resist is baked (step 540), and unexposed areas of resist are dissolved away together in developer solution (step 550), leaving a stair case elevation pattern of “pedestals” of resist, where the bottom pedestal of resist has the largest area and the top pedestal of resist has the smallest area.

A final smoothing layer of resist is spin-coated over the previous patterned stacks of resist and soft-baked (step 560). The final layer is also exposed to UV light with the photomask used in defining the edges of the lenses for the first layer of resist (step 570), subjected to a post exposure bake (step 575) and developed (step 580), such that the final patterned layer of resist covers all other layers of resist. The resulting stack of resist layers is thermally cured (step 590) to allow the final layer to flow smoothly over the other resist layers to cover the layers and fill in between the layers. The surface tension of the melted final layer of resist pulls the final resist layer into a lens shape having a curved surface. To finalize the lens shape and size, the lens is blanket exposed (i.e., no mask is used) with UV to cross-link the polymer material in order to harden the lens (step 595). A final thermal treatment can be applied, if necessary, to cure the lenses further to improve performance in subsequent processing (step 598).

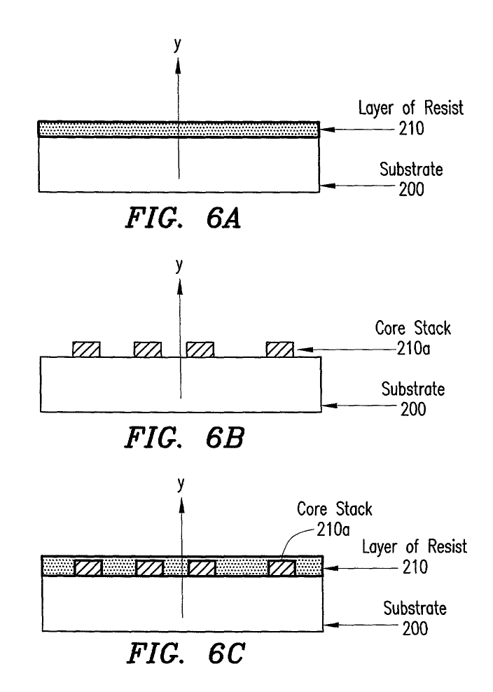

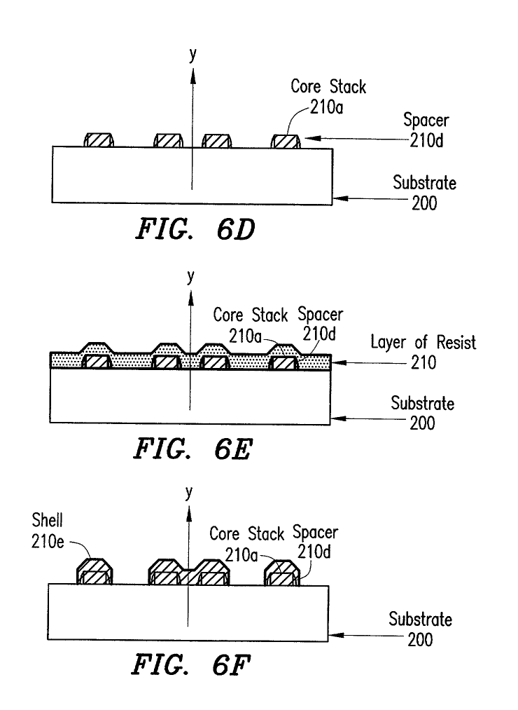

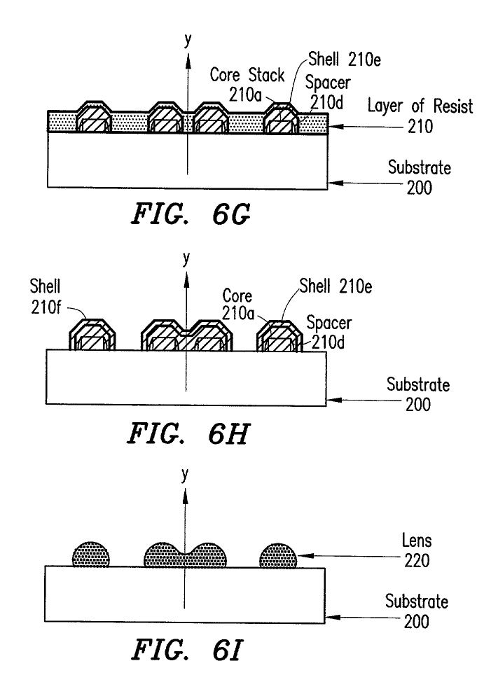

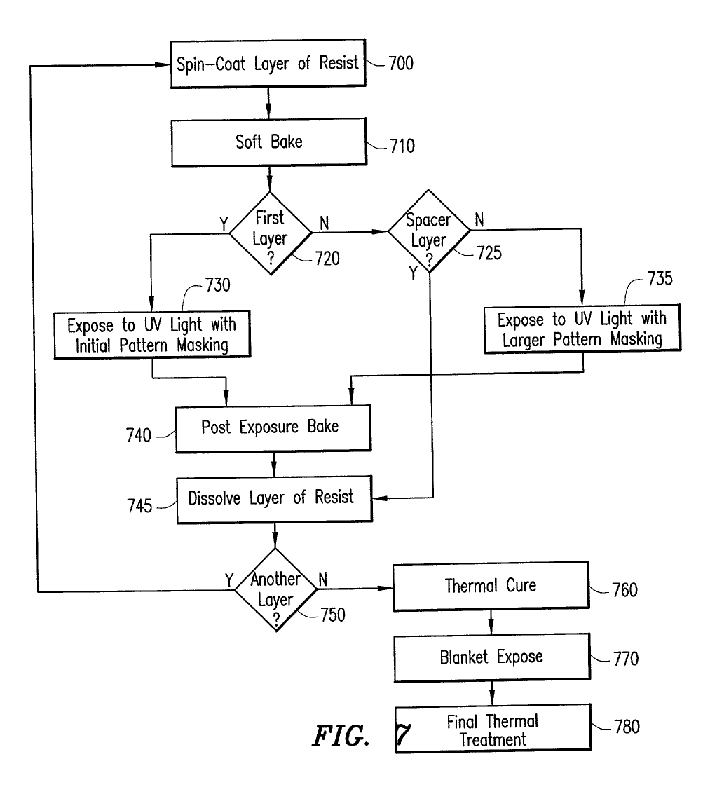

In a further embodiment, as shown in FIGS. 6A-6I, a micro-optics device, such as an array of microlenses, is fabricated in a series of shell steps. As can be seen in FIG. 6A, core layer of an epoxy-based negative-working photo-definable resist 210 is first deposited onto substrate 200, such as quartz or glass. Core layer of resist 210 is patterned photolithographically, as described above. The resulting pattern is one or more core stacks 210a of resist material, as shown in FIG. 6B.

In FIG. 6C, second layer of resist 210 is shown deposited (e.g., spin-coated) over defined core stacks 210a in the first layer of resist. Second layer of resist 210 is dissolved in developer solution without patterning (no UV exposure). Due to loading effects, spacers 210d of resist material are left at the base of each core stack 210a, as shown in FIG. 6D. However, it should be noted that in certain embodiments, spacer 210d resist material may not be needed, and therefore, the micro-optics device can be fabricated using the core layer of resist and any subsequent layer(s) as described below. Subsequent layers of resist 210 can be deposited (e.g., spin-coated) over defined stacks 210a (and spacers 210d) of resist, as shown in FIG. 6E, and patterned photolithographically to define one or more shells 210e of resist overlying one or more stacks 210a (and spacers 210d) of resist. As shown in FIG. 6F, each shell 210e of resist material has a larger area than the combination of stack 210a and spacers 210d. The edges of resist shell 210e define the diameter of the lens. The number of shells 210e used depends upon the desired height, width and curvature of the lens.

As shown in FIG. 6G, final smoothing layer of resist 210 is spin-coated over previous patterned shells 210e of resist and patterned photolithographically to define final shell 210f of resist, as shown in FIG. 6H. Resulting shells 210e and 210f of resist are thermally cured (i.e., soft baked) to allow final shell 210f of resist to flow smoothly over other resist shells 210e, and to allow surface tension resulting from the thermal cure process to pull the shape of final shell 210f of resist into lens 220 having a curved surface. To finalize the shape and size of lens 220, as shown in FIG. 61, lens 220 is blanket exposed (i.e., no mask is used) with UV to cross-link the polymer material in order to harden lens 220. By defining a series of shells 210e and 210f, resulting lens 220 will have smooth round sidewalls with a hemispherical shape.

FIG. 7 is a flowchart illustrating exemplary steps for fabricating a micro-optics device in accordance with the embodiment shown in FIGS. 6A-6I. A core layer of an epoxy-based negative-working photo-definable polymer resist is spin-coated onto a substrate (step 700). If desired, the substrate with the layer of resist thereon can be thermally cured (step 710) as a precursor to photolithography. In the initial photolithography step (step 720), the core layer of resist is patterned by exposing the resist to ultraviolet (UV) light (e.g., 350 nm-400 nm) with a photo-mask having an initial pattern masking (step 730), subjecting the resist to a post exposure bake (step 740) and dissolving away unexposed regions of the resist in a developer solution (step 740), leaving one or more core stacks of resist material.

If one or more spacers of resist material are desired to widen the lens without increasing the height of the lens (step 750), one or more additional layers of resist can be spin-coated over the defined core stacks in the first layer of resist (step 700), soft-baked (step 710) and, to define the spacers (step 725), dissolved in developer solution without patterning (no UV exposure) (step 745). Thereafter, if additional layers of resist are to be applied (depending upon the desired height and curvature of the lens) (step 750), each additional layer of resist is spin-coated over the previously defined core stack and spacers of resist (step 700), soft-baked (step 710) and photolithographically patterned using a photo-mask having a larger pattern masking that is capable of producing one or more shells of resist that are larger in area than the combination of the core stack and spacers of resist and that overly one or more of the core stacks and spacers of resist (step 735). The resist is baked (step 740), and unexposed areas of resist are dissolved away in developer solution (step 740), leaving a stack of “shells”, where the bottom core stack has the smallest area and the top shell has the largest area.

A final smoothing layer of resist (step 750) is spin-coated over the previous patterned shells of resist (step 700) and soft-baked (step 710). The final layer is also exposed to UV light (step 735), subjected to a post exposure bake (step 740) and developed (step 740), such that the final patterned layer of resist covers all other layers of resist. The resulting shells of resist are thermally cured (step 760) to allow the final layer to flow smoothly over the other resist layers, and to allow the surface tension of the melted final layer of resist to pull the final resist layer into a lens shape having a curved surface. To finalize the lens shape and size, the lens is blanket exposed (i.e., no mask is used) with UV to cross-link the polymer material in order to harden the lens (step 770). A final thermal treatment can be applied, if necessary, to cure the lenses further to improve performance in subsequent processing (step 780).

As will be recognized by those skilled in the art, the innovative concepts described in the application can be modified and varied over a wide range of applications. Accordingly, the scope of patented subject matter should not be limited to any of the specific exemplary teachings discussed, but is instead defined by the following claims,

We claim:

1. A method for fabricating a micro-optics device, comprising:
depositing one or more layers of a resist on a substrate, said resist being formed of an optically-transparent polymer material having a viscosity sufficient to allow stacking of said one or more layers of said resist at a thickness of at least 10 microns for each of said layers of said resist;
patterning said one or more layers of said resist photolithographically to define a discrete relief structure; and
thermally curing said discrete relief structure to form said micro-optics device.

2. The method of claim 1, further comprising:
depositing a smoothing layer of said resist having a viscosity equivalent to or less than the viscosity of said one or more layers of said resist forming said discrete relief structure; and
blanket exposing said micro-optics device to ultraviolet light to harden said micro-optics device.

3. The method of claim 1, wherein said discrete relief structure comprises at least first and second stacks of said resist, said step of patterning further comprising:
defining said second stack of said resist overlying said first stack of said resist, said second stack of said resist having an area less than an area associated with said first stack of said resist.

4. The method of claim 1, wherein said discrete relief structure comprises a core stack of said resist and at least one shell portion of said resist, said step of patterning further comprises:
defining said at least one shell portion of said resist overlying said core stack of said resist, said at least one shell portion of said resist having an area larger than an area associated with said core stack of said resist.

5. The method of claim 4, further comprising:
depositing at least one spacer layer of said resist on said core stack of said resist; and
selectively dissolving said at least one spacer layer of said resist without exposure to ultraviolet light to produce at least one spacer portion of said spacer layer of said resist overlying said substrate and adjacent to said core stack of said resist to define said discrete relief structure.

6. The method of claim 1, wherein said step of depositing comprises:
depositing a first layer of said resist on said substrate;
exposing said first layer of said resist to ultraviolet light using a first photomask having exposed areas therein;
depositing a second layer of said resist on said exposed first layer of said resist; and
exposing said second layer of said resist to ultraviolet light using a second photo-mask having exposed areas therein smaller than said exposed areas of said first photomask and overlying said exposed areas of said first photo-mask.

7. The method of claim 6, wherein said step of patterning comprises:
developing said first and second layers of said resist together using a developer solution capable of removing unexposed areas of said first and second layers of said resist to form said discrete relief structure having first and second stacks of said resist, said second stack of said resist having an area less than an area associated with said first stack of said resist.

8. The method of claim 1, wherein said resist is transparent to optical wavelengths equal to or greater than 350 nm.

9. The method of claim 1, wherein said resist is formed of an epoxy-based polymer resist material.

10. The method of claim 9, wherein said resist is stable at temperatures above 250° C.

11. The method of claim 1, wherein said resist has a viscosity of at least 2,000 centipoise.

12. A method for fabricating a micro-optics device, comprising:
depositing a layer of a resist on a substrate, said resist being formed of an optically-transparent polymer material having a viscosity of at least 2,000 centipoise;
patterning said layer of said resist photolithographically to define at least a portion of a discrete relief structure; and
thermally curing said discrete relief structure to form said micro-optics device.

13. The method of claim 12, further comprising:
depositing at least one additional layer of said resist on said portion of said discrete relief structure; and
patterning said at least one additional layer of said resist photolithographically to define said discrete relief structure.

14. The method of claim 13, wherein said at least one additional layer of said resist comprises a smoothing layer of said resist, and further comprising:
blanket exposing said micro-optics device to ultraviolet light to harden said micro-optics device.

15. A micro-optics device, comprising:
a substrate; and
one or more layers of a resist patterned photolithographically on said substrate to define a discrete relief structure, each of said one or more patterned layers of said resist having a shape formed from thermal curing of said one or more patterned layers of said resist, each of said one or more layers of said resist being formed of an optically-transparent polymer material having a viscosity sufficient to allow stacking of said one or more layers of said resist at a thickness of at least 10 microns for each of said layers of said resist.

16. The device of claim 15, wherein said one or more patterned layers of said resist comprises:
a first patterned layer of said resist; and
a second patterned layer of said resist overlying said first patterned layer of said resist.

17. The device of claim 16, further comprising:
a smoothing layer of said resist having a viscosity equivalent to or less than the viscosity of said one or more layers of said resist defining said discrete relief structure, said smoothing layer of said resist being patterned photolithographically, thermally cured and blanket exposed to ultraviolet light to harden said micro-optics device.

18. The device of claim 16, wherein said first patterned layer of said resist comprises a first stack of said resist and said second patterned layer of said resist comprises at least one additional stack of said resist overlying said first stack of said resist, said at least one additional stack of said resist having an area less than an area associated with said first stack of said resist.

19. The device of claim 16, wherein said first patterned layer of resist comprises a core stack of said resist and said second patterned layer of said resist comprises at least one shell of said resist overlying said core stack of said resist, said at least one shell of said resist having an area larger than an area associated with said core stack of said resist.

20. The device of claim 19, wherein said at least one patterned layer of said resist further comprises:
at least one spacer portion of said resist defined without exposure to ultraviolet light overlying said substrate and adjacent to said core stack of said resist.

21. The device of claim 15, wherein said resist is formed of an epoxy-based polymer resist material.

22. The device of claim 21, wherein said resist is stable at temperatures above 250° C.

23. The device of claim 15, wherein said resist is transparent to optical wavelengths equal to or greater than 350 nm.

24. The device of claim 15, wherein said substrate is transparent to light within a particular range of wavelengths.

25. The device of claim 15, wherein said resist has a viscosity of at least 2,000 centipoise.
